(19) United States
(12) Patent Application Publication
(10) Pub. No.: US 2013/0047517 A1
(43) Pub. Date: Feb. 28, 2013

(54) CAT-DOOR ASSEMBLY AND METHOD OF USE

(71) Applicant: Eric J. Peterson, Fort Lauderdale, FL (US)

(72) Inventor: Eric J. Peterson, Fort Lauderdale, FL (US)

(21) Appl. No.: 13/218,442

(22) Filed: Aug. 25, 2011

(51) Int. Cl. A01K 29/00; E06B 5/00; E06B 3/80

(52) U.S. Cl. 49/463; 160/184; 49/506

(57) ABSTRACT

A pet-door assembly and method of use includes providing a pet-door assembly with a body having a first end, a second end, and a length separating the first end from the second end, a securing member coupled at the second end of the body, the securing member having a first end and a second end, the first end and the second end being shaped to fit within and engage a frame of a sliding door, and a plurality of strips each having a first end, a second end, and a length separating the first end from the second end, the first end of the plurality of strips coupled to the securing member and the length of the plurality of strips being less than half the length of the body. The method further includes the step of mechanically fixing the pet door in overlapping relation with an opening in a wall, the opening having a horizontally-sliding door disposed. within, the horizontally-sliding door having a first position that obstructs the opening and a second position that leaves at least a portion of the opening overlapped by the pet door unobstructed.

### FIELD OF THE INVENTION

The present invention relates generally to pet doors placed in openings in building structures, and, more particularly, relates to a cat-door assembly with flexible strips that allows a cat to easily displace only one or a few strips to exit and enter a building structure.

### BACKGROUND OF THE INVENTION

Openings built into doors, windows, and walls of buildings for the ingress and egress of domesticated animals (pets) has been utilized previously by many home owners and residents. Many of these doors are designed for use of all pets to enter and leave sections of the home on their own volition without an owner's supervision or interaction, serving as a convenient means for animals to go outside and come back into the structure. These doors give pets a variety of physical and emotional benefits, while seeking to be more convenient for owners and residents.

Most known pet doors are either permanently or semi-permanently installed into the door, window, or wall of a building structure. One installation location targeted by prior-art pet doors is within a sliding door assembly, i.e., a sliding glass door movable within a frame. These prior-art pet doors are fixedly attached to the sliding door structure, e.g., the frame. Because of the installation method, these prior-art pet doors do not have the ability of being quickly and/or easily removed. While they are in place, the owner of the structure is unable to easily relocate the pet door or to fully operate the sliding glass door. This can, and often does, provide security issues both in being able to quickly open the door and, more frequently, being unable to securely shut/lock the door.

Known pet door assemblies that are easily removable from the designated opening in a building structure do not allow for efficient containment of air conditioning inside the home and often allow insects or bugs inside, partly due to the fact that the pet doors allow the door to stay open longer than necessary.

Pet doors for use with sliding glass doors generally require installation or assembly of multiple pieces into the opening of the sliding glass door or require a separate door entirely. These doors also require spacers and adjustments for the height of the door assembly based upon the user's door frame specifications and are expected to be at least semi-permanently installed into the frame of the glass doors, requiring weather strips and seals. Moreover, prior-art pet door assemblies block light and are very noticeable once installed. Also, many prior pet doors have a multiplicity of parts to them, which are expensive to manufacture, inventory, ship, and install.

Also important is that currently-available pet doors, which allow the pets to enter and exit, are not geared toward the sensibilities of domesticated cats. Cats, by nature, are generally more sensitive to noises, weigh less than most pets for which these doors are meant for, move slower, and have less strength or desire to lift weight with their faces.

A majority of prior-art pet doors or pet portals utilize a solid door connected to a hinge. The hinged door swings from the top and allows the pet to come inside or go outside whenever pressure is applied to the door. Cats have shown to have highly sensitive noses, particularly in comparison with dogs, and are prone to avoid swinging-door type pet doors due to the forces that must be applied by the cat's face in order to operate the door.

Other prior-art pet doors utilize solid large flexible flaps which are one piece and attached to hinges, thereby requiring the pet to also push and apply pressure to get the entire flap to open in order for the cat to enter and exit. These doors are not conducive or supportive to the above-mentioned sensitivities of cats. One other prior-art method of allowing pets to enter and exit requires the use of sensors and other motion detectors; which require electricity and are, for the most part, cumbersome, expensive, and difficult to install.

Therefore, a need exists to overcome the problems with the prior art as discussed above.

### SUMMARY OF THE INVENTION

The invention provides a cat-door assembly that overcomes the herein fore-mentioned disadvantages of the heretofore-known devices and methods of this general type and that provides an entry and exit portal to a building structure that allows a cat to easily displace one or more strips of flexible material with little force required. The strips, when not displaced, provide a barrier that prevents air from within the building from exiting and vice versa.

With the foregoing and other objects in view, there is provided, in accordance with the invention, a pet-door assembly that includes an upper body portion with a first end, a second end, and a length of at least 3.5 feet separating the first end from the second end. A securing member is coupled to the second end of the upper body portion, where the securing member has a first end and a second end, with the first end and the second end being shaped to fit within and engage a frame of a sliding door. A lower ingress/egress portion features a plurality of strips, a first end, a second end, and a length separating the first end from the second end. The first end of the lower ingress/egress portion is coupled to the securing member and the length of a majority of the plurality of strips are less than half the length of the body.

In accordance with a further feature of the present invention, the securing member has a first end, a second end opposite to the first end, and a width separating the first end from the second end, where the width is less than about 20 inches.

In accordance with another feature of the present invention, the first end of the securing member has a first edge and a second edge opposite to and separated from the first edge by a length that is less than about 8 inches, with a portion of the total length having a step inserted thereto, the step having a length less than about 2 inches.

In accordance with yet another feature of the present invention, the second end of the securing member has a first edge and a second edge opposite to and separated from the first edge by a length of no less about 8 inches.

In accordance with an additional feature of the present invention, the securing member has at least one face with a first edge, a second edge opposite to the first edge, the first edge and second edge being separated by a width no less than the width separating at least one surface on the first and second end of the securing member.

In accordance with another feature, an embodiment of the present invention also includes a handle mechanically coupled to the securing member.

In accordance with a further feature of the present invention, the upper body portion and the plurality of strips have a material that is pliable.

In accordance with a further feature of the present invention, at least two of the plurality of strips have a width of no more than 4 inches.

In accordance with another feature of the present invention, the plurality of strips defines a plurality of slits, having substantially no space between each strip.

In accordance with an additional feature of the present invention, the plurality of strips have a length no more than 4 feet.

In accordance with yet another feature, an embodiment of the present invention includes a pet-door assembly that includes a wall defining an opening therein, a horizontally-sliding door disposed within the opening and having a first position that obstructs the opening and a second position that leaves at least a portion of the opening unobstructed, and a pet door disposed within the opening and overlapping the unobstructed portion of the opening, where the pet door includes a body with a first end coupled to an upper portion of the opening, a second end opposite the first end, and a length separating the first end from the second end, a securing member coupled to the second end of the body, the securing member having a first end shaped to engage with the horizontally-sliding door and a second end shaped to engage with a door frame, and a plurality of strips each having a first end, a second end, and a length separating the first end from the second end, the first end of the plurality of strips coupled to the securing member and the length of the plurality of strips being less than half the length of the body.

In accordance with another feature of the present invention, the body includes a substantially planar surface parallel to the surface of the wall defining an opening therein, the horizontally-sliding door includes a substantially planar surface parallel to the surface of the wall defining an opening therein, and the substantially planar surface of the body is non-co-planar with the substantially planar surface of the horizontally-sliding door, wherein the horizontally-sliding door is able to move into a filly overlapping position with the pet-door assembly.

In accordance with the present invention, a method of providing a pet ingress and egress to a building structure includes the steps of providing a pet-door assembly that includes a body having a first end, a second end, and a length separating the first end from the second end, a securing member coupled at the second end of the body, the securing member having a first end and a second end, the first end and the second end being shaped to fit within and engage a frame of a sliding door, and a plurality of strips each having a first end, a second end, and a length separating the first end from the second end, the first end of the plurality of strips coupled to the securing member and the length of the plurality of strips being less than half the length of the body. The method further includes the step of mechanically fixing the pet door in overlapping relation with an opening in a wall, the opening having a horizontally-sliding door disposed within, the horizontally-sliding door having a first position that obstructs the opening and a second position that leaves at least a portion of the opening overlapped by the pet door unobstructed.

In accordance with another feature of the present invention, the method of providing a pet ingress and egress to a building structure includes the step of coupling the pet door in a position in relation to the horizontally-sliding door and door frame, such that at least portion of the body, securing member, and plurality of strips are in an overlapping position with at least a portion of the horizontally-sliding door and door frame.

In accordance with yet a further feature of the present invention, the method of providing a pet ingress and egress to a building structure includes the step of placing the horizontally-sliding door in a second position, such that the pet door may be pulled by the securing member from the overlapping position with relation to an opening in the wall, and the horizontally-sliding door may then be placed in second position that completely obstructs the opening in the wall.

Although the invention is illustrated and described herein as embodied in a cat-door assembly, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two, The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure, In this document, the term “longitudinal” should be understood to mean in a direction corresponding to an elongated direction of the cat-door assembly from the end which it is installed to the end having the plurality of strips.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a fragmentary, front elevational view of a prior-art sliding door disposed within and completely obstructing an opening formed within a wall of a building structure;

FIG. 2 is a fragmentary, front elevational view of the prior-art sliding door of FIG. 1 disposed within an opening in a wall of a building structure with the sliding door positioned to provide an unobstructed portion of the opening;

FIG. 3 is a fragmentary, front elevational view of a sliding door disposed within an opening in a wall of a building structure with the sliding door positioned to provide an unobstructed portion of the opening and a cat door disposed to overlap the unobstructed portion of the opening in accordance with an exemplary embodiment of the invention;

FIG. 4 is a fragmentary, elevational side view of the cat-door assembly disposed in a position within an opening in a wall of a building structure with the sliding door positioned such that a cat-door assembly is engaged with the horizontally-sliding door and the horizontally-sliding door frame assembly in accordance with an exemplary embodiment of the invention;

FIG. 5 is a fragmentary, elevational side view of the cat-door assembly disposed in a position within an opening in a wall of a building structure with the sliding door positioned such that a cat-door assembly is not engaged with the horizontally-sliding door and the horizontally-sliding door frame assembly in accordance with an exemplary embodiment of the invention;

FIG. 6 is a fragmentary, perspective view of the cat-door assembly and shows a securing member, a plurality of strips, and a body portion in accordance with present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides an easily removable cat-door assembly that quickly attaches to a horizontally-sliding door. The invention can be provided in many embodiments for attachment to any opening where a sliding or other door is installed thereto, with said embodiments being disposed to help minimize changes in the room temperature inside the dwelling or building, prevent bugs, insects, and other creatures from entering while the pet door is opened, and maintain an aesthetically pleasing appearance.

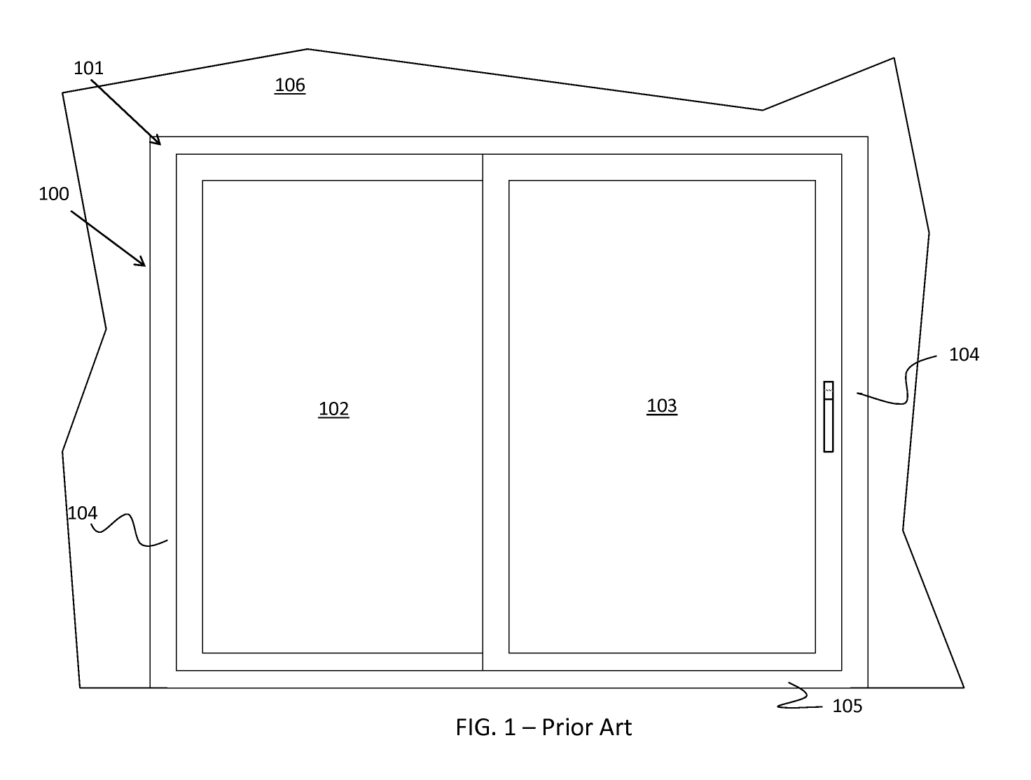

Referring now to FIG. 1, one embodiment of a prior-art pet door is shown in a fragmentary, front elevational view. FIG. 1 illustrates a cutout front view of a wall 106 defining a rough opening 100 therein, where a horizontally-sliding door assembly 101 is installed. The horizontally-sliding door assembly 101 includes a frame 104 that supports a stationary door 102 and a horizontally-sliding door 103. The stationary door 102, however, is not, necessarily, unable to slide within the door frame assembly 101.

The wall 106 defines the rough opening 100, as illustrated in FIG. 1, and further referenced below. The horizontally-sliding door 103 translates side-to-side on a track 105 located on the horizontally-sliding door frame assembly 101, allowing the horizontally-sliding door to be in numerous positions along the track 105. The position of the horizontally-sliding door 103, as illustrated in FIG. 1, is in a position that, along with the stationary door 102, completely obstructs the rough opening 100. When in such position, the rough opening 100 of the building to which the horizontally-sliding door frame assembly 101 is attached is enclosed and does not allow anything to enter or leave without first translating the horizontally-sliding door 103 into another position. In one embodiment, the horizontally-sliding door 103 and stationary door 102 are made at least partially out of glass, with a non-glass frame. In other embodiments, the horizontally-sliding door 103 or stationary door 102 may be entirely made out of wood or other non-glass materials.

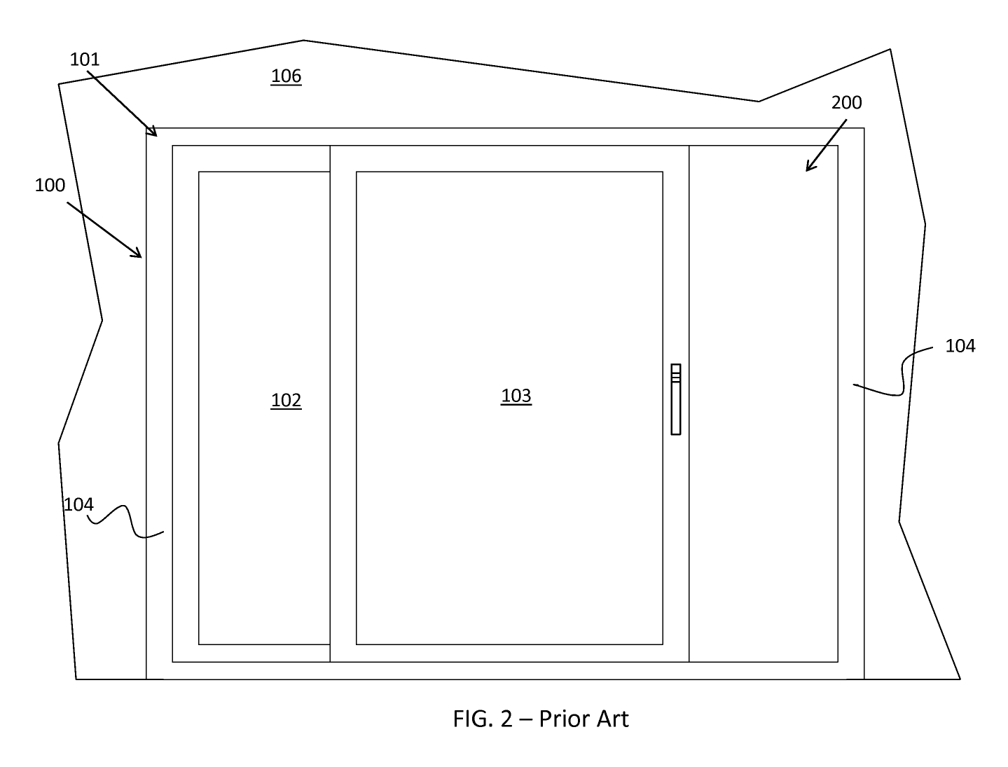

Referring now to FIG. 2, the prior-art sliding door of FIG. 1 is shown disposed within the rough opening 100 in the wall 106 of the building structure with the horizontally-sliding door 103 translated to a second position that leaves a least a portion 200 of the opening 100 unobstructed. The second position of the horizontally-sliding door 103 is such that an animal, e.g., a cat, is able to pass through the unobstructed portion 200 of the rough opening 100.

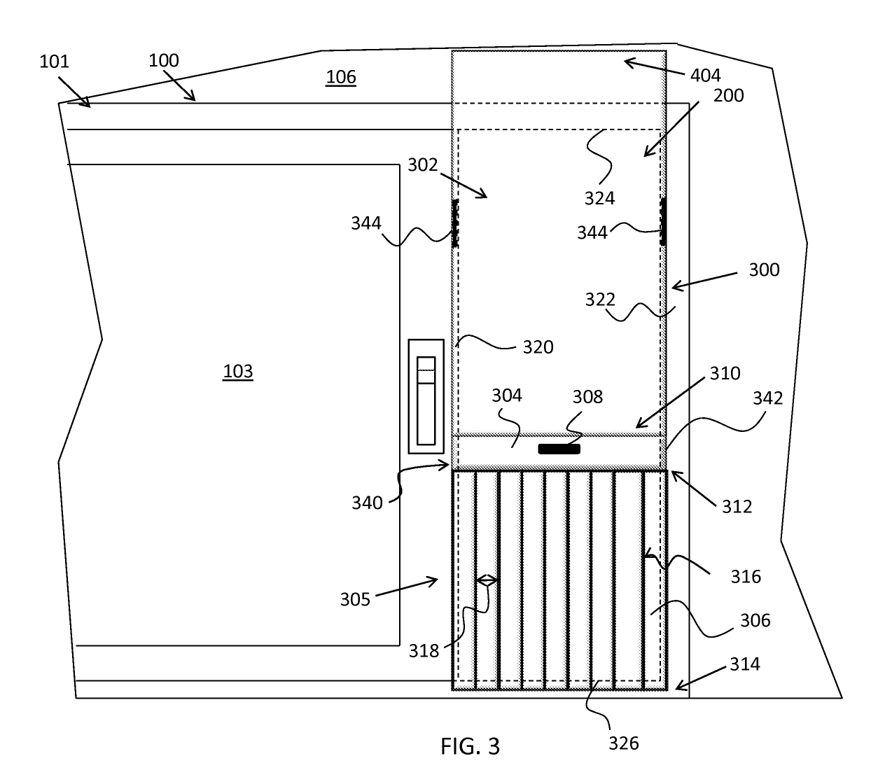

Referring now to FIG. 3, a fragmentary front elevational view of a sliding door 103 disposed within a rough opening 100 in a wall 106 is shown. FIG. 3 shows several advantageous features of the present invention, but, as will be described below, the invention can be provided in several shapes, sizes, combinations of features and components, and varying numbers and functions of the components. In one embodiment, as illustrated in FIG. 3, an embodiment of an inventive cat-door assembly 300 is shown installed in a position that overlaps the unobstructed portion 200 of the rough opening 100. Although there is no required defined width of the unobstructed portion 200 of the rough opening 100, which is created by the second position of the horizontally-sliding door 103, the width of the cat-door assembly 300 should be sufficient for the cat-door assembly 300 to block the unobstructed portion 200 of the rough opening 100.

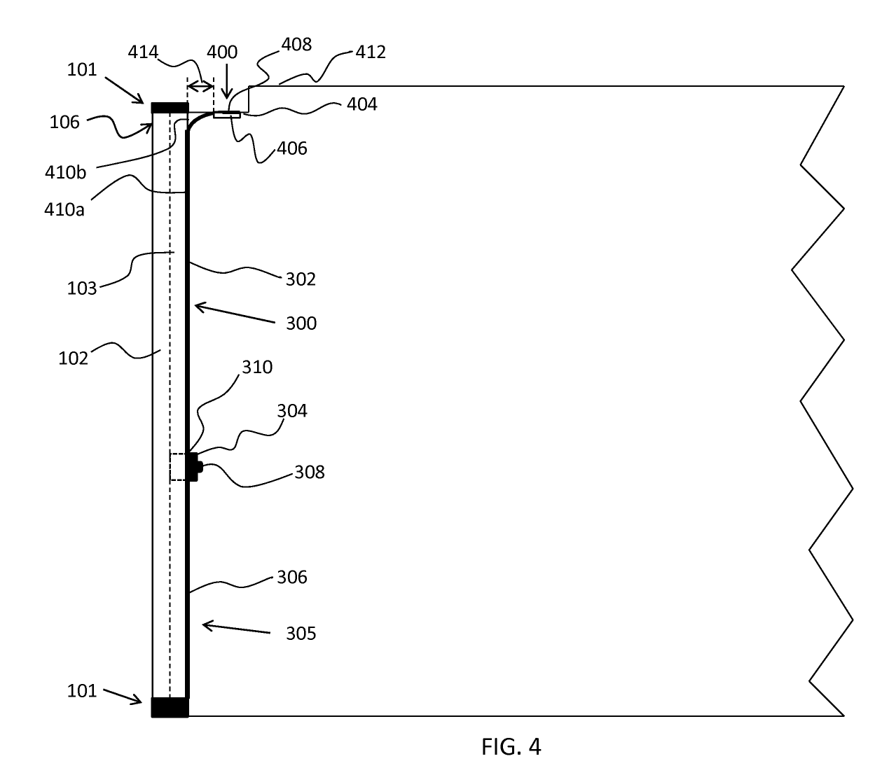

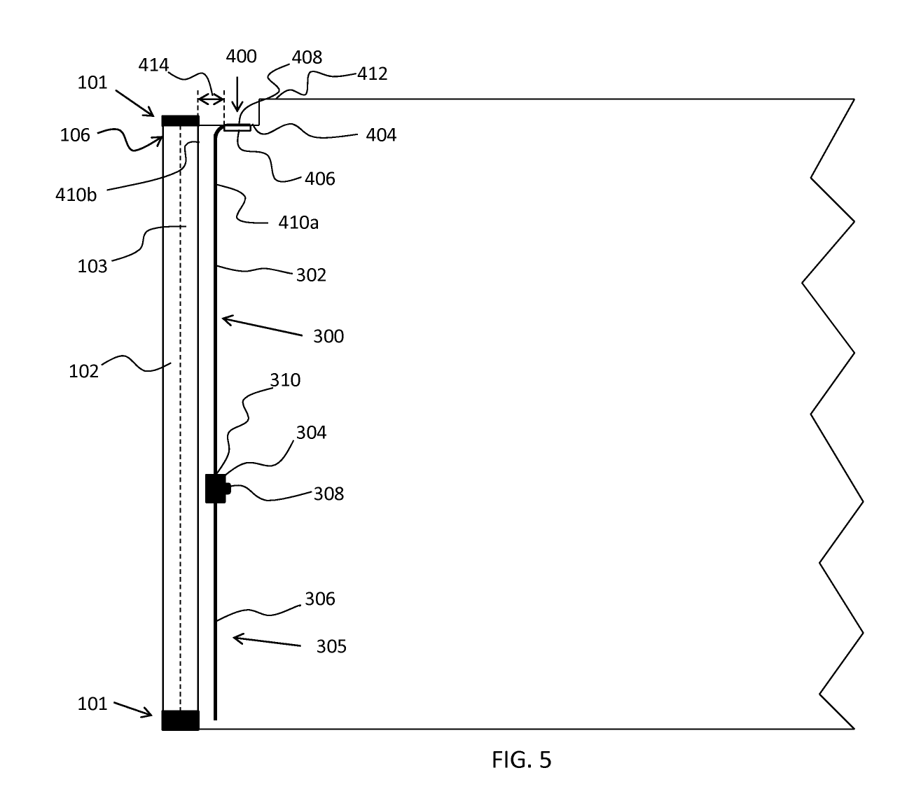

More specifically, and with reference to FIGS. 3-5, it can be seen that in one embodiment of the present invention, the cat-door assembly 300 has three main portions: (1) a body 302; (2) a securing member 304; and (3) a lower ingress/egress portion 305 featuring a plurality of strips 306. The body portion 302 of the cat-door assembly 300 has a first end 404 and a second end 310 that is opposite to the first end 404. The second end 310 of the cat-door assembly 300 is coupled to the securing member 304. When the cat-door assembly 300 is installed, the upper portion 404 of the body 302 of the cat-door assembly 300 is connected to an upper portion 400 (shown in FIGS. 4 and 5) of the rough opening 101), the size of which may be reduced by the presence of the horizontally-sliding door frame assembly 101 in which the doors 102, 103 are supported.

Once installed, the cat-door assembly 300 is preferably placed in overlapping relation with portions of the horizontally-sliding door 103 and the horizontally-sliding door assembly 101. As referenced herein, “overlapping” is defined as having a portion or edge of one surface extend to, or past, a portion or edge of another surface. These portions may include the leading edge 320 of the horizontally-sliding door 103, a portion of the upper edge 324 of the horizontally-sliding door frame assembly 101, a portion of the lower edge 326 of the horizontally-sliding door frame assembly 101, and a portion of the horizontal inside edge 322 of the horizontally-sliding door frame assembly 101 where the horizontally-sliding door 103 normally makes contact with the frame when it is in the position shown in FIG. 1.

Overlapping the unobstructed portion 200 of the rough opening 100, as described below, does not mean that it is completely overlapping the unobstructed portion 200 at all times and in all areas. As will be described below, one embodiment, the cat-door assembly 300 has two primary positions when installed: one while it is engaged, via a securing member 304, to the horizontally-sliding door 103 and the horizontally-sliding door frame assembly 101, and a second position, when it is not engaged, via the securing member 304, to the horizontally-sliding door 103 or the horizontally-sliding door frame assembly 101. In the second position, the cat-door assembly 300 is able to hang freely from the area where it is attached. In other embodiments, the cat-door assembly 300 will not completely overlap the unobstructed opening 200, such as when the horizontally-sliding door 103 is in a position greater than the width of the cat-door assembly 300, or when a pet, specifically a cat, is entering or exiting the building through the cat-door assembly 300.

The securing member 304, as described below, has two positions once installed within the unobstructed opening 200. In a first position, shown in FIG. 4, the securing member 304 is coupled at a first of its ends 340 (shown in FIG. 3) to the horizontally-sliding door 103 and at a second of its ends 342 (identified in FIG. 3) to the horizontally-sliding door frame assembly 101. The shapes of each of the ends of the securing member 304 are selected to provide mechanical coupling between the securing member 304, the horizontally-sliding door 103 and/or the horizontally-sliding door frame assembly 101.

The lower portion 305 features a plurality of flexible strips 306 having a first end 312 and a second end 314 and that extend from the securing member 304 to the lower portion 326 of the horizontally-sliding door frame assembly 101. The plurality of strips 306 form the door portion of the cat-door assembly 300 and make it easy and convenient for a pet and, more specifically, a cat, to enter and exit the building structure by simply displacing one or more strips in the of the plurality of strips 306 in order to enter or leave the building to which the cat-door assembly 300 is attached, Advantageously, when a cat is entering or exiting the building through the cat-door assembly 300, only selective ones of the plurality of strips 306 need to be displaced by the animal's body. Of course, the animal must displace any pet door, starting first with its face and, more particularly, its sensitive nose, in order for the animal to enter or exit. With the present invention, advantageously, a cat only needs to separate two strips with its face to create an opening that it can then expand with its less-sensitive body. The ability to displace a door by moving only a single small strip of flexible material with its nose provides a tremendous advantage over prior art doors. The displacement of only a small section of the entire opening also has the benefits of exhausting less heat or air conditioning (depending on the season) and presents less of a chance of catching the animal's tail, because no door swings shut as in the prior art. In addition, the strips effectively knock off debris from the animal's body as it passes through the strips.

In one embodiment, the first end 312 is essentially a continuation of the body 302 sandwiched between the securing member 304. In another embodiment of the present invention, the first end 312 is coupled to the securing member 304 using adhesives, screws, bolts, or other similar attaching mechanisms.

To prevent air conditioning within the building from escaping, an embodiment of the present invention, as illustrated in FIG. 3, provides a plurality of slits 316 between the plurality' of the strips 306, where a width of the slits 316 is substantially zero so that the slits 316 provide substantially no space between each strip. “Substantially no space” as defined herein, means leaving little to no air to pass through.

To provide a way for a pet, specifically a cat, to apply very little force to the plurality of strips to enter and exit the cat-door assembly 301), one embodiment of the present invention has individual strips having a width 318 no more than 4 inches for at least two strips. The width 318 of other strips may vary, but in order for the cat to have at least some strips where it can apply less force with its face or paws, two strips should be less than 4 inches. Other embodiments of the present invention may vary as to the width 318 of each individual strip, but as the width increases convenience and force required by the cat to translate the plurality of strips 306 decreases.

In other embodiments, the cat-door assembly 300 may have more than one securing member 304 that attach to the horizontally-sliding door 103 and the horizontally-sliding door frame assembly 101. The securing member 304 allows for the cat-door assembly 300 to be easily detachable from the horizontally-sliding door 103 when the user would like to open or close the horizontally-sliding door 103, for instance, to lock the house at night, while at the same time serving as the connecting and supporting piece between the body 302 and the plurality of strips 306.

FIG. 4 provides an elevational side view of the inventive cat-door assembly 300 installed within an opening adjacent the horizontally-sliding door frame assembly 101 and with the securing member 304 engaged between and held in place by the horizontally-sliding door 103 and the horizontally-sliding door frame assembly 101. The view of FIG. 4 specifically shows that when the securing member 304 is engaged between and held in place by the horizontally-sliding door 103 and the horizontally-sliding door frame assembly 101, the body 302 and horizontally-sliding door 103 have substantially planar surfaces 410a, 410b parallel to the glass portions of the horizontally-sliding door 103 and to the wall 106 that defines the opening 100.

The body portion 302 also has upper surface areas that, when installed within the opening 100, are non-co-planar with the glass in the sliding door 103. In this orientation, the horizontally-sliding door 103 is able to move into a fully overlapping position with the cat-door assembly 300. Although the body 302 and horizontally-sliding door 103 are described herein as being “substantially planar,” that term, as used herein, is not intended to indicate an entire lack of curvature or surface features.

In one embodiment, the body 302 is provided with one or more magnets 344 to help it attach to magnets of an opposite polarity that are coupled to the horizontally-sliding door 103 and portions of the horizontally-sliding door frame assembly 101. In other embodiments, the body 302 can be provided with adhesive, e.g., tape or other attachments, that help the body 302 adhere to the horizontally-sliding door 103 and portions of the horizontally-sliding door frame assembly 101. Allowing the body 302 to better adhere to the horizontally-sliding door 103 and/or horizontally-sliding door frame assembly 101 facilitates the resilience of the body 302 to remain in an overlapping relationship with the horizontally-sliding door 103 and the horizontally-sliding door frame assembly 101. This overlapping relationship prevents air conditioning from escaping the building to which the cat-door assembly 300 is attached.

Moreover, as seen in FIGS. 4 and 5, in one embodiment of the present invention, the upper portion of the body 302 has a slight curvature at a point extending from the area of the upper portion 400 of the rough opening 100 where it is attached. The definition of the “upper portion of the opening,” as stated herein and below, is defined to mean a location at or above the upper-most portion of the horizontally-sliding door 103 as it is installed within the rough opening 100 of the wall 106. For example, the horizontally-sliding door frame assembly 101, and the area just direct above it, would effectively be the upper portion of the opening. in other embodiments, the body can be attached to the ceiling of the building structure 412. In one preferred embodiment of the present invention, the body 302 is coupled to the upper portion 400 of the opening 100 at a distance 414 from about 0 inches to about 2 inches away from the horizontally-sliding door 103. The preferred distance is such that the body 302, as is shown in FIG. 5, is easily removed from the sliding path of the horizontally-sliding door 103 so that the horizontally-sliding door 103 can easily open and close without the cat-door assembly 300 impeding its movement. Therefore, although the cat-door assembly 300 is referred to as being “substantially planar” in its installed position, the general definition of the term “substantially planar” can be interpreted as a general flat surface with possible surface features and a slight curvature at some points.

FIG. 5 provides an elevational side view of the inventive cat-door assembly 300 showing the cat-door assembly 300 in a position where the securing member 304 is not engaged with the horizontally-sliding door 103 and horizontally-sliding door frame assembly 101. This position of the cat-door assembly 300, with reference to the horizontally-sliding door 103, allows the cat-door assembly 300 to hang freely from the surface to which it is attached. This position is advantageous in that the horizontally-sliding door 103 may be opened and closed as desired. In other embodiments, the securing plate 406 that secures the cat-door assembly 300 within the opening 100 is mounted closer to the horizontally-sliding door frame assembly 101 than is illustrated in FIG. 5. In this embodiment, the securing member 304 is naturally biased toward the opening 100 and rests against the horizontally-sliding door 103 when the horizontally-sliding door 103 is in its closed position.

In accordance with one embodiment of the present invention, the body 302 has a total length greater than 3.5 feet. This minimum length assures that the body 302 has sufficient length to extend down and mate with the edges of the horizontally-sliding door 103 and horizontally-sliding door frame assembly 101. The length also allows sufficient distance between the upper-most extent of the body 302 and the securing member 304, so that the securing member 304 can be used as a handle to move the entire cat-door assembly 300 out of the path of the horizontally-sliding door 103 (compare FIGS. 4 and 5). In accordance with an embodiment of the present invention, the length of the body 302 is greater than or equal to twice the length of the plurality of strips 306. in addition, when provided in transparent material, the body 302 provides a window for viewing outside.

Referring now to FIG. 5, the body 302 has an upper portion 408 of its length exposed for attachment to a building structure. It can be seen that the upper portion 408 of the body 302 is coupled to the upper portion 400 of the opening 100, such that the upper portion 408 of the body 302 is substantially parallel to the upper portion 400 of the opening 100. “Substantially parallel,” is defined herein as having two planes that are equal or approximately equal in distance from each other in more than one point along the planes. Although it is assumed. that when the body 302 is attached to the upper portion 400 of the rough opening 100, the two planes will be parallel, different embodiments of the invention might provide for a distance between those planes that is not equal, but very close, in distance. In one embodiment, the body 302 has holes for screws or nails to be inserted therein, with a solid plate 406 superposed over the body, so the weight of the cat-door assembly 300 can be more evenly distributed. In other embodiments, the upper portion 408 of the body 302 has adhesive, screws, nails or other attaching mediums in order for it to be coupled with the upper portion 400 of the rough opening 100 without the use of a solid plate 406 superposed over the upper portion 408 of the body 302. When an upper portion 408 of the body 302 is coupled to the building as stated above, it allows the cat-door assembly 300 to be easily removed and coupled to the horizontally-sliding door 103 and horizontally-sliding door frame assembly 101, while not interfering with the use of the horizontally-sliding door 103, when not engaged therewith.

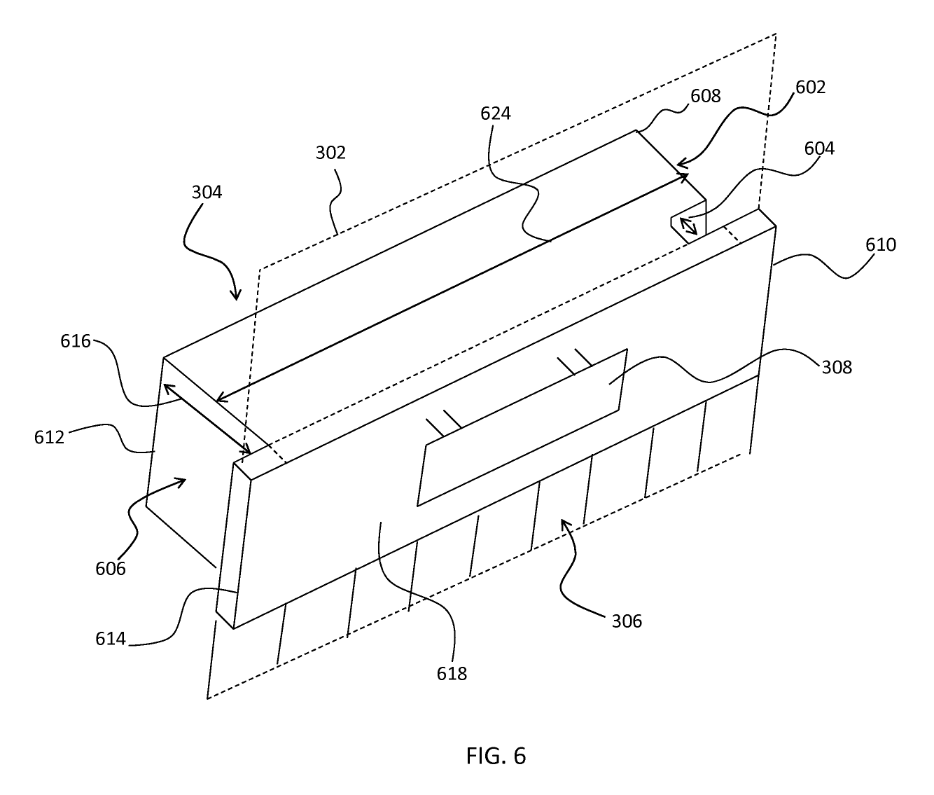

FIG. 6 provides a perspective downward-looking view of the securing member 304. As seen in FIG. 6, the securing member 304 has a first end 602 and a second end 606, opposite to the first end 602. The first end 602 and second end 606 are provided with shapes that help engage with the horizontally-sliding door frame assembly 101 and horizontally-sliding door 103, respectfully. Shaping the ends to engage with the horizontally-sliding door 103 and the horizontally-sliding door frame assembly 101 provides the cat-door assembly 300 with stability and allows the body 302, securing member 304, and plurality of strips 306 to come into an overlapping position with the horizontally-sliding door 103 and the horizontally-sliding door frame assembly 101. In one embodiment of the present invention, the width separating the first end 602 and second end 606 is less than 20 inches. In other embodiments, the width may be more than 20 inches, but in order for the securing member 304 to engage with the horizontally-sliding door 103 and the horizontally-sliding door frame assembly 101, it, of course, should be less than or equal to a width of the unobstructed portion 200 of the rough opening 100. In further embodiments of the present invention, the securing member 304 may be placed in a position to engage or disengage with the horizontally-sliding door 103 and the horizontally-sliding door frame assembly 101 by holding on to an attached handle 308. The handle 308 may be coupled to the securing member 304 allowing the user to easily and efficiently, with a single hand, move the cat-door assembly 300 into a position to engage or disengage, while using the other hand to close or open the horizontally-sliding door 103 into the desired position. In other embodiments, the securing member 304 may not have a handle 308, but rather have the user move the securing member 304 into position using just the securing member 304.

In one embodiment, the first end 602 of the securing member, as referenced in FIG. 6, has a first edge 608 and second edge 610, opposite to the first edge 608, with a length that is less than about 8 inches. Lengths greater than 8 inches remain, however, within the spirit and scope of the invention. In accordance with one embodiment of the present invention, the first end 602 has a step 604 formed therein with a length, as reflected by the arrows in FIG. 6, that is less than about 2 inches. The depth of the step 604 is through the length of the securing member 304 as seen in FIG. 5. Other embodiments of the present invention may have more than one step 604 or a length greater than 2 inches, depending on the design of the horizontally-sliding door frame assembly 101. For example, the horizontal inside edge 322 of the horizontally-sliding door frame assembly 101 may have only one edge of the frame protruding, so the edge 322 fits within the step 604. The horizontal inside edge 320 of the horizontally-sliding door frame assembly 101 provides a coupling mechanism for the securing member 304 when in an engaged position, as shown in FIG. 4. To move into the disengaged position, as shown in FIG. 5, the horizontally-sliding door 103 is moved away from the horizontally-sliding door frame assembly 101 and the securing member 304 is able to be easily removed from the horizontal inside edge 322 of the horizontally-sliding door frame assembly 101. Other embodiments of a horizontally-sliding door frame assembly 101 may have two horizontally inside edges protruding, requiring two steps. The step 604 is one of the two ends that allow the securing member 304 to engage and disengage quickly and conveniently by moving the horizontally-sliding door 103 to or from the securing member 304.

In one embodiment, the second end 606 of the securing member, as referenced in FIG. 6, has a first edge 612 and second edge 614, opposite to the first edge 612, with a length that is less than about 8 inches. In other embodiments, the second end 606 may have a length greater than 8 inches. In one embodiment, the second end 606 has a portion of its length 616 substantially parallel and substantially adjacent with at least one surface of the horizontally-sliding door 103. Moreover, a portion of the second end 606 has a length 616 having flat surface of no less than 0.25 inches. “Substantially adjacent” as defined herein, means sharing a border or immediately following a border of a surface. The length 616 of flat surface, represented by the arrows in FIG. 6, allows for the second end 606 to contact the edge of horizontally-sliding door 103. In other embodiments, the second end 606 may have any surface shape such that presents a contact point between the second end 606 and the horizontally-sliding door 103. Depending on the shape of the horizontally-sliding door 103, the shape of the ends 602, 606 may vary so that they can couple with said horizontally-sliding door 103 and the frame 104.

Still referring to FIG. 6, in order for a portion of the body 302, securing member 304, and plurality of strips 306 to overlap the horizontally-sliding door 103 and the horizontally-sliding door frame assembly 101, the securing member 304 has at least one face 618 that overlaps the horizontally-sliding door 103 and the horizontally-sliding door frame assembly 101. The face 618 has a first edge 614 and second edge 610, opposite to the first edge 614, separated by a width no less than, or equal to, the width 624 separating the first end 602 from the second end 606 of the securing member 304. For example, if the width 624 separating the first end 602 and second end 606 of the securing member 304 is 18 inches, then the width of the face 618, in accordance with one embodiment, is greater than 18 inches so that the face 618 can overlap the horizontally-sliding door 103 and the horizontally-sliding door frame assembly 101. In one embodiment of the present invention, the face 618 of the securing member 304 is superposed over the same material that the plurality of strips 306 or body 302 is made out of such that there is a tighter seal, as discussed below. In other embodiments, the material of the securing member 304 will contact the horizontally-sliding door 103 and the horizontally-sliding door frame assembly 101.

As seen in FIG. 6, in one embodiment of the present invention, the face 618 is superposed over the body portion 302, such that the body portion 302 is sandwiched. between the face 618 and a portion of the securing member 304. In one embodiment of the present invention, the securing member 304 is constructed from hardened plastic. In other embodiments, the securing member 304 is constructed from metal, wood, rubber or other material with a hardness that will sustain the force of the horizontally-sliding door 103 and the horizontally-sliding door frame assembly 101 when engaged therein. In yet further embodiments of the present invention, the securing member 304 may be two or more combined pieces or one solid molded piece with the body 302 and plurality of strips 306 coupled thereto using adhesives, screws, nails, bolts, or other means of securing the body 302 and plurality of strips 306 to the securing member 304.

For the ease and convenience of the user for the cat-door assembly 300, the body 302 and plurality of strips 306 are made out of a material that is pliable. This allows the body 302 to be easily moved to engage and disengage with the horizontally-sliding door 103 and the horizontally-sliding door frame assembly 101. In one embodiment of the present invention, the body 302 and plurality of strips 306 are made of a plastic material allowing the edges of the body 302 and plurality of strips 306 to create a better seal with the horizontally-sliding door 103 and the horizontally-sliding door frame assembly 101. In other embodiments, the plurality of strips 306 and body 302 are made of either a polymer or composite material. “Pliable” as defined herein, means the ability of a material to bend. repeatedly without breaking. This is not to mean that the entire body 302 is pliable. For example, in other embodiments of the invention, the upper body 302 may be made partially out of a pliable material where bending is required, as shown in FIGS. 4 and 5, such that the cat-door assembly may be moved into and out of a locking position with the horizontally-sliding door 103 and the horizontally-sliding door frame assembly 101 and made of a harder, non-pliable, material where the body 302 overlaps the horizontally-sliding door 103 and the horizontally-sliding door frame assembly 101. In yet further embodiments of the present invention, the body 302 and plurality of strips 306 are made of a material that is transparent or translucent. Having a material that is transparent or translucent gives a more aesthetic appearance and allows the animal to see through the pet door. Other embodiments of the present invention may not include a translucent or transparent material.

A pet-door assembly and method of use has been disclosed, where the pet-door assembly that has a body that attaches to the wall or surface of a building, allowing the pet door assembly to be easily attachable and removable to the frame of a horizontally-sliding door assembly and horizontally sliding door. The pet-door assembly further discloses a convenient and easy means for a pet, specifically a cat, to enter and leave the building to which the cat-door assembly is attached, while at same being aesthetically pleasing and maintaining the air conditioning within the building. The other features of the invention have also been disclosed that add convenience for the user and owner of the cat door, but are not necessary and not intended to be limited to the particular details disclosed herein.

What is claimed is:

1. A pet-door assembly comprising:
an upper body portion having a first end, a second end, and a length of at least 3.5 feet separating the first end from the second end;
a securing member coupled at the second end of the upper body portion, the securing member having a first end and a second end, the first end and the second end being shaped to fit within and engage a frame of a sliding door; and
a lower ingress/egress portion having a plurality of strips, a first end, a second end, and a length separating the first end from the second end, the first end of the lower ingress/egress portion being coupled to the securing member and the length of the plurality of strips being less than half the length of the body.

2. The pet-door assembly according to claim 1, further comprising:
a mounting bracket coupled to the upper portion of the body and disposed for attachment to a building structure.

3. The pet-door assembly according to claim 1, wherein the securing member has a first end, a second end opposite to the first end, and a width separating the first end from the second end, the width being less than about 20 inches.

4. The pet-door assembly according to claim 1, wherein the first end of the securing member has a first edge and a second edge opposite to and separated from the first edge by a length that is less than about 8 inches, with a portion of the total length having a step inserted. thereto, the step having a length less than about 2 inches.

5. The pet-door assembly according to claim 1, wherein the second end of the securing member has a first edge and a second edge opposite to and separated from the first edge by a length of no less about 8 inches.

6. The pet-door assembly according to claim 3, wherein the securing member has at least one face with a first edge, a second edge opposite to the first edge, the first edge and second edge being separated by a width no less than the width separating at least one surface on the first and second end of the securing member.

7. The pet-door assembly according o claim 1, wherein the securing member has a handle mechanically coupled thereto.

8. The pet-door assembly according to claim 1, wherein the upper body portion and the plurality of strips having a material that is pliable.

9. The pet-door assembly according to claim 1, wherein at least two of the plurality of strips have a width of no more than 4 inches.

10. The pet-door assembly according to claim 1, wherein the plurality of strips defines a plurality of slits, having substantially no space between each strip.

11. The pet-door assembly according to claim 1, wherein the plurality of strips have a length no more than 4 feet.

12. A pet-door assembly comprising:
a wall defining an opening therein;
a horizontally-sliding door disposed within the opening and having a first position that obstructs the opening and a second position that leaves at least a portion of the opening unobstructed; and
a pet door disposed within the opening and overlapping the unobstructed portion of the opening, the pet door having:
a body with a first end coupled to an upper portion of the opening, a second end opposite the first end, and a length separating the first end from the second end;
a securing member coupled to the second end of the body, the securing member having a first end shaped to engage with the horizontally-sliding door and a second end shaped to engage with a door frame; and
a plurality of strips each having a first end, a second end, and a length separating the first end from the second end, the first end of the plurality of strips coupled to the securing member and the length of the plurality of strips being less than half the length of the body.

13. The pet-door assembly according to claim 12, wherein:
the body includes a substantially planar surface parallel to the surface of the wall defining an opening therein;
the horizontally-sliding door includes a substantially planar surface parallel to the surface of the wall defining an opening therein; and
the substantially planar surface of the body is non-co-planar with the substantially planar surface of the horizontally-sliding door, wherein the horizontally-sliding door is able to move into a fully overlapping position with the pet-door assembly.

14. The pet-door assembly according to claim 12, wherein:
the body has a first edge and a second edge opposite to the first edge; and
at least a portion of the first edge of the body overlaps at least one side of the horizontally-sliding door.

15. The pet-door assembly according to claim 12, wherein at least one end of the securing member has at least one step formed therein and shaped to mate with at least one surface of the horizontally-sliding door.

16. The pet-door assembly according to claim 12, wherein at least one end of the securing member has a portion of the first end that substantially parallels at least one surface of the horizontally-sliding door, such that the portion of the first end of the securing member and the horizontally-sliding door are substantially adjacent to each other.

17. The pet-door assembly according to claim 12, wherein the upper portion of the body is coupled to the upper portion of the wall defining the opening therein, such that the upper portion of the body and the upper portion of the wall are substantially parallel.

18. A method of providing a pet ingress and egress to a building structure, the method comprising:
providing a pet-door assembly that includes:
a body having a first end, a second end, and a length separating the first end from the second end;
a securing member coupled at the second end of the body, the securing member having a first end and a second end, the first end and the second end being shaped to fit within and engage a frame of a sliding door; and
a plurality of strips each having a first end, a second end, and a length separating the first end from the second end, the first end of the plurality of strips coupled to the securing member and the length of the plurality of strips being less than half the length of the body; and
mechanically fixing the pet door in overlapping relation with an opening in a wall, the opening having a horizontally-sliding door disposed within, the horizontally-sliding door having a first position that obstructs the opening and a second position that leaves at least a portion of the opening overlapped by the pet door unobstructed.

19. The method of providing a pet ingress and egress to a building structure according to claim 18, further comprising:
coupling the pet door in a position in relation to the horizontally-sliding door and door frame, such that at least portion of the body, securing member, and plurality of strips are in an overlapping position with at least a portion of the horizontally-sliding door and door frame.

20. The method of providing a pet ingress and egress to a building structure according to claim 18, further comprising:
placing the horizontally-sliding door in a second position, such that the pet door may be pulled by the securing member from the overlapping position with relation to an opening in the wall, and the horizontally-sliding door may then be placed in second position that completely obstructs the opening in the wall.
